(19) United States
(12) Patent Application Publication
(10) Pub. No.: US 2016/0049135 A1
(43) Pub. Date: Feb. 18, 2016

(54) BRIEFING SYSTEM, WEARABLE DEVICE, AND NOTE PRESENTATION METHOD FOR BRIEFING

(71) Applicant: Coretronic Corporation, Hsin-Chu (TW)

(72) Inventors: Chia-Chien Wu, Hsin-Chu (TW); Wei-Hsin Kan, Hsin-Chu (TW); Cheng-Yen Huang, Hsin-Chu (TW)

(21) Appl. No.: 14/788,818

(22) Filed: Jul. 1, 2015

(30) Foreign Application Priority Data
Aug. 15, 2014 (TW) 103128148

(51) Int. Cl. G09G 5/12; G02B 27/01; G09G 5/00; G06F 3/147; G06F 3/14

(52) U.S. Cl. CPC G09G 5/12; G06F 3/147; G06F 3/1423; G09G 5/006; G02B 27/017; G02B 2027/0178; G09G 2370/16; G09G 2360/04; G09G 2320/10

(57) ABSTRACT

A briefing system, a wearable device, and a note presentation method for briefing are provided. The briefing system includes a control unit, a projection unit and a wearable device. The projection unit is adapted to connect to the control unit in a wired/wireless manner and display a briefing content. The wearable device is adapted to communicate with the control unit via a protocol. The wearable device has a display screen. The control unit transmits a note content corresponding to the briefing content to the wearable device via the protocol. The wearable device displays the received note content on the display screen of the wearable device.

### CROSS-REFERENCE TO RELATED APPLICATION

This application claims the priority benefit of Taiwan application serial no. 103128148, filed on Aug. 15, 2014. The entirety of the above-mentioned patent application is hereby incorporated by reference herein and made a part of this specification.

### BACKGROUND OF THE INVENTION

1. Field of the Invention

The invention relates to an application technique of a wearable device, and more particularly, to a briefing system related to a wearable device and a note presentation method for briefing.

2. Description of Related Art

Briefing is a skill cannot be ignored in all walks of life. A presenter mainly expresses information to the audience through a briefing content. Patents related to briefing include U.S. Issued U.S. Pat. No. 8,659,635 and U.S. Patent Publication No. 20140125558.

The information disclosed in this BACKGROUND OF THE INVENTION section is only for enhancement of understanding of the background of the described technology and therefore it may contain information that does not form the prior art that is already known to a person of ordinary skill in the art. Further, the information disclosed in the BACKGROUND OF THE INVENTION section does not mean that one or more problems to be resolved by one or more embodiments of the invention was acknowledged by a person of ordinary skill in the art.

### SUMMARY OF THE INVENTION

The invention is directed to a briefing system, a wearable device and a note presentation method for briefing, which are capable of, under the circumstance where the audience can only view a briefing content, allowing the user to view a note content corresponding to the briefing content at any time through the wearable device, such that the briefing may be performed successfully by the presenter, and smoothness and performance of the briefing may also be improved. Other objects and advantages of the invention can be further illustrated by the technical features broadly embodied and described as follows.

To achieve one, a part, or all of the objects or other objects, a briefing system is provided according to an embodiment of the invention. The briefing system includes a control unit, a projection unit and a wearable device. The projection unit is adapted to connect to the control unit in a wired/wireless manner and configured to display a briefing content. The wearable device is adapted to communicate with the control unit via a protocol. The wearable device has a display screen. The control unit transmits a note content corresponding to the briefing content to the wearable device via the protocol. The wearable device displays the received note content on the display screen.

In an embodiment of the invention, the control unit controls the projection unit to display and switch a page of the briefing content according to a briefing switch signal, and the wearable device displays and switches a page of the note content on the display screen according to a note switch signal.

In an embodiment, the note switch signal includes a current page of the note content for the wearable device to display after receiving the current page of the note content. The current page of the note content is corresponding to a current page of the briefing content.

In another embodiment, the note content includes a plurality of note pages, the note switch signal includes a specific page signal corresponding to the briefing content, and the specific page signal is corresponding to one of the note pages, so that the wearable device is capable of displaying the note page corresponding to the current page of the briefing content after receiving the specific page signal.

In an embodiment of the invention, the briefing system further includes a remote-control device. The remote-control device is electrically connected to the control unit, and configured to transmit the briefing switch signal to the control unit.

To achieve one, a part, or all of the objects or other objects, a wearable device is further provided according to an embodiment of the invention. The wearable device includes a display screen, a protocol receiving module and a processing unit. The protocol receiving module is adapted to communicate with a control unit via a protocol. The control unit is adapted to connect to the projection unit in a wired/wireless manner and display a briefing content. The processing unit is coupled to the display screen and the protocol receiving module. The processing unit obtains a note content corresponding to the briefing content from the control unit via the protocol and displays the note content on the display screen.

In an embodiment of the invention, the processing unit of the wearable device receives a note switch signal from the control unit via the protocol; and, when the processing unit receives the note switch signal, the wearable device switches a page of the note content according to the note switch signal.

In an embodiment, the note switch signal includes a current page of the note content, and the wearable device displays according to the current page of the note content. The current page of the note content is corresponding to a current page of the briefing content.

In another embodiment, the note content includes a plurality of note pages, the note switch signal includes a specific page signal corresponding to the briefing content, and the specific page signal is corresponding to one of the note pages, so that the wearable device is capable of displaying the note page corresponding to the current page of the briefing content according to the specific page signal.

To achieve one, a part, or all of the objects or other objects, a note presentation method for briefing is further provided according to an embodiment of the invention, which includes the step of: displaying a briefing content by a projection unit; transmitting a note content corresponding to the briefing content to a wearable device via a protocol by a control unit; and displaying the received note content by the wearable device.

In an embodiment of the invention, the step of transmitting the note content to the wearable device via the protocol includes: executing a note transmitting program by the control unit, wherein the note transmitting program is linked to the briefing content; executing a note receiving program by the wearable device; and transmitting the note content via the protocol by the note transmitting program to the wearable device via the note receiving program.

In an embodiment of the invention, the note presentation method for briefing further includes: receiving a briefing switch signal by the control unit; displaying and switching a page of the briefing content by the projection unit according to the briefing switch signal; generating a note switch signal by the control unit; and displaying and switching a page of the note content by the wearable device according to the note switch signal.

In an embodiment of the invention, the note switch signal includes a current page of the note content, and the step of displaying and switching the page of the note content by the wearable device according to the note switch signal includes: after receiving the current page of the note content by the wearable device, displaying the current page by the wearable device, wherein the current page of the note content is corresponding to a current page of the briefing content.

In an embodiment of the invention, the note content includes a plurality of note pages, the note switch signal includes a specific page signal corresponding to the briefing content, the specific page signal is corresponding to one of the note pages, and the step of displaying and switching the page of the note content by the wearable device according to the note switch signal includes: after receiving the specific page signal by the wearable device, displaying the note page corresponding to the current page of the briefing content by the wearable device.

To achieve one, a part, or all of the objects or other objects, a note presentation method for briefing is further provided according to an embodiment of the invention, which is adapted to a wearable device. The note presentation method includes the step of: executing a note receiving program, and receiving a note content corresponding to a briefing content via a protocol, wherein the briefing content is linked to a note transmitting program, the note transmitting program is executed by a control unit, and the briefing content is displayed by a projection unit; and displaying the received note content on a display screen of the wearable device.

In an embodiment of the invention, the note presentation method for briefing further includes: receiving a note switch signal, and switching a page of the note content according to the note switch signal.

In an embodiment of the invention, the note switch signal includes a current page of the note content, and the step of switching the page of the note content according to the note switch signal includes: after receiving the current page of the note content, displaying the current page by the wearable device, wherein the current page of the note content is corresponding to a current page of the briefing content.

In an embodiment of the invention, the note content includes a plurality of note pages, the note switch signal includes a specific page signal corresponding to the briefing content, the specific page signal is corresponding to one of the note pages, and the step of switching the page of the note content according to the note switch signal includes: after receiving the specific page signal, displaying the note page corresponding to the current page of the briefing content.

Based on the above, in the briefing system according to the embodiments of the invention, the projection unit is adapted to connect to the control unit and display the briefing content transmitted by the control unit, and the wearable device communicates with the control unit via the protocol so as to display the note content corresponding to the briefing content. In the embodiments of the invention, the briefing system may transmit the note content (e.g., memo note) corresponding to the briefing content to the wearable device by using the note transmitting program in the control unit (e.g., the notebook computer, the smart phone, the tablet computer) and the note receiving program in the wearable device. The briefing system may also use the briefing switch signal to make the briefing content viewed by the audience through the projection unit corresponding to the memo note viewed by the user through the wearable device. Accordingly, under the circumstance where the audience can only view the briefing content, the user may view the memo note at any time through the wearable device, such that the briefing may be performed successfully, and smoothness and performance of the briefing may also be improved.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are schematic diagrams illustrating two briefing systems according to embodiments of the invention.

FIG. 1C is a schematic diagram illustrating another briefing system according to an embodiment of the invention.

FIG. 2 is a schematic diagram illustrating a display screen on a wearable device in consistent with embodiments of the invention.

FIG. 3A, FIG. 3B and FIG. 3C are schematic diagrams illustrating three note presentation methods for briefing according to embodiments of the invention.

FIG. 4 is a flowchart illustrating the note presentation method for briefing performed by using the control unit and the wearable device in FIG. 1 according to an embodiment of the invention.

### DESCRIPTION OF THE EMBODIMENTS

Reference will now be made in detail to the preferred embodiments of the invention, examples of which are illustrated in the accompanying drawings. Wherever possible, the same reference numbers are used in the drawings and the description to refer to the same or like parts.

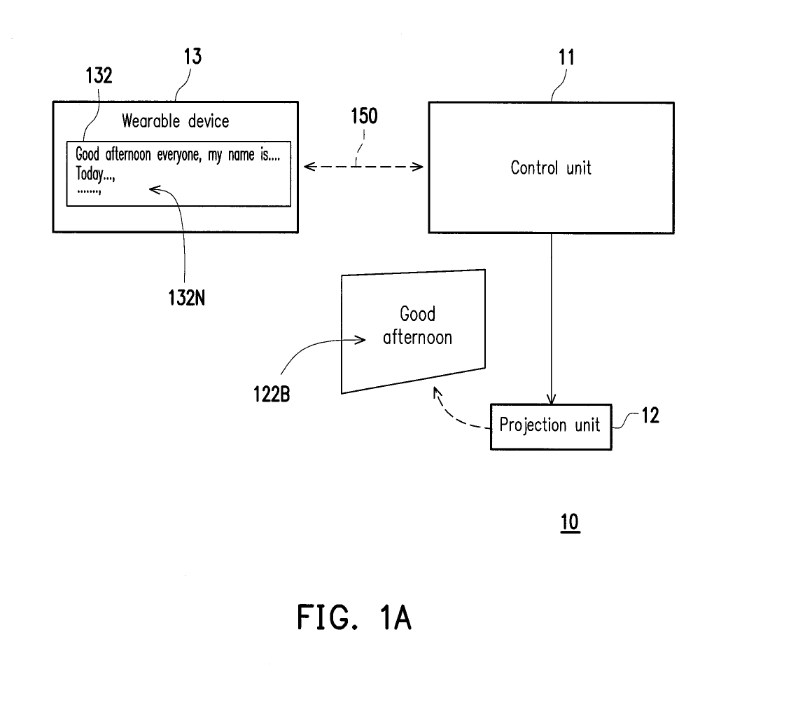

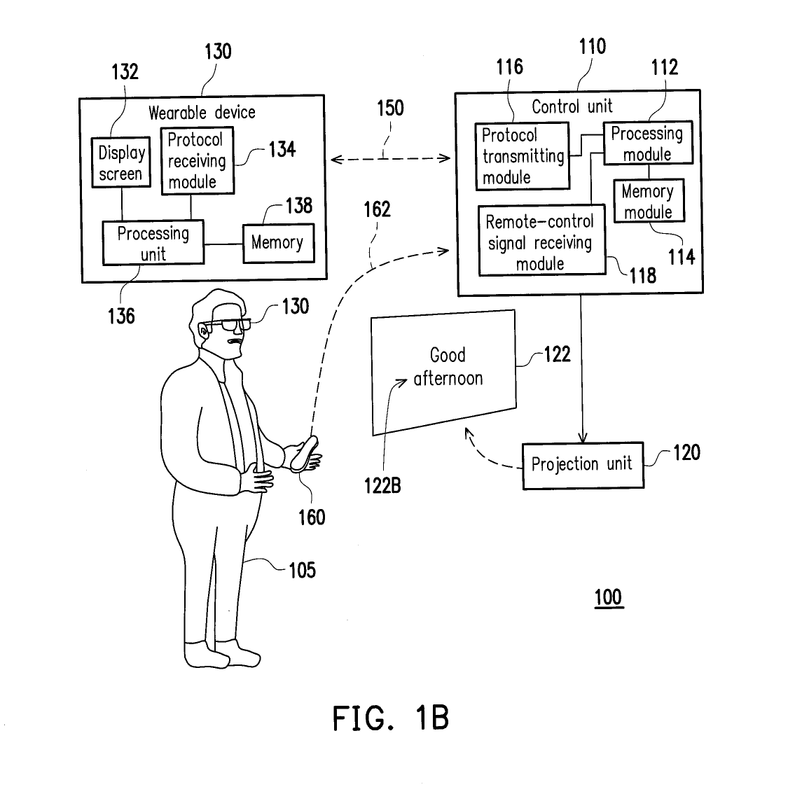

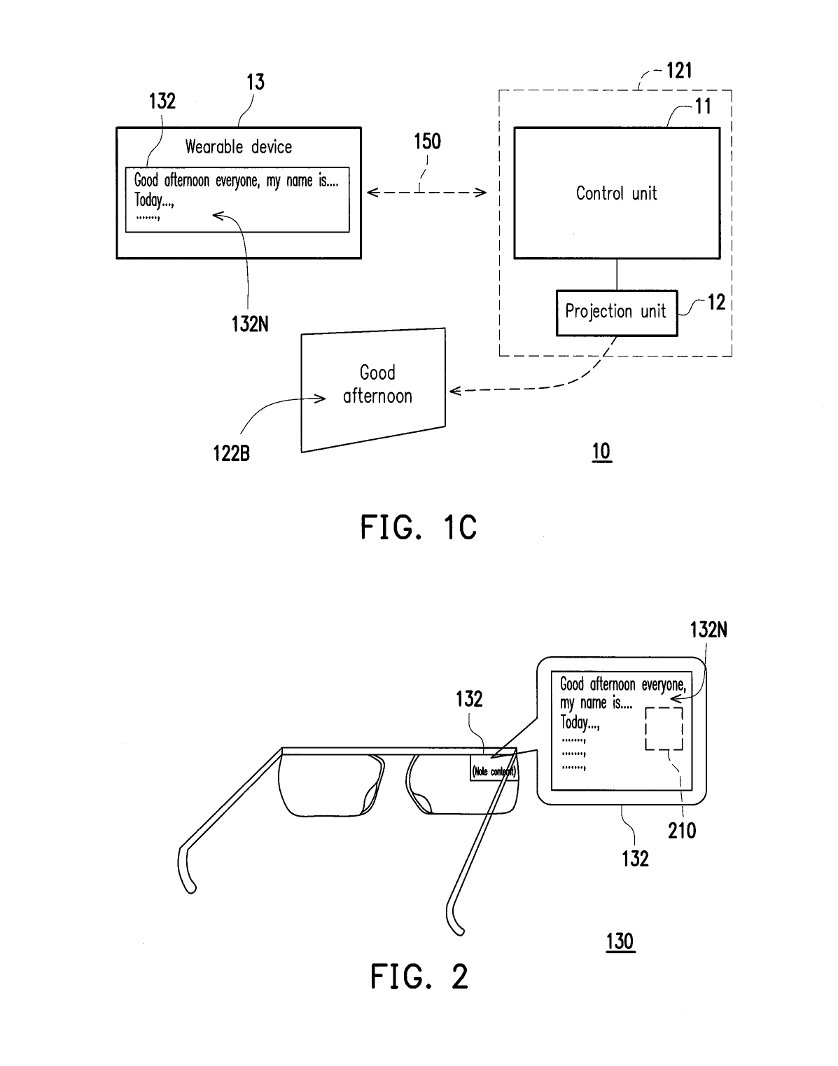

FIG. 1A is a schematic diagram illustrating a briefing system 10 according to an embodiment of the invention. The briefing system 10 of the embodiment includes a control unit 11, a projection unit 12 and a wearable device 13. The wearable device 13 has a display screen 132. In the embodiment, the projection unit 12 is adapted to connect to the control unit 11 in a wired/wireless manner and displays a briefing content 122B. The wearable device 13 communicates with the control unit 11 via a communication protocol 150. The control unit 11 starts a briefing playing program (e.g., the PowerPoint program of Microsoft), receives the briefing content 122B, detects a note content 132N (e.g., a memo note) corresponding to the briefing content 122B, and transmits the note content 132N to the wearable device 13 via the communication protocol 150 so that the wearable device 13 may display the received note content 132N on the display screen 132; and meanwhile, the control unit 11 transmits the briefing content 122B to the projection unit 12 so that the briefing content 122B displayed by the projection unit 12 on a projection plane is corresponding to the note content 132N displayed by the wearable device 13 on the display screen 132.

More specifically, FIG. 1B is a schematic diagram illustrating a briefing system 100 according to an embodiment of the invention. The briefing system 100 of the embodiment mainly includes a control unit 110, a projection unit 120 and a wearable device 130, and the wearable device 130 includes a display screen 132. The control unit 110 of the embodiment communicates with the wearable device 130 near the eyes of a user 105 via a communication protocol 150 and provides a note content so that the display screen 132 of the wearable device 130 may display a memo note corresponding to the current briefing content 122B. Accordingly, under the circumstance where the audience can only view the briefing content 122B presented on a projection plane 122 by the projection unit 120, the user 105 is able to naturally and carelessly read the memo note at any time, so that the user 105 can make up for conditions caused by insufficient preparation or stage fright while improving smoothness and performance for the briefing.

In the embodiment, the control unit 110 may be an electronic device such as a desktop computer, a personal computer, a notebook computer, a tablet computer or a cell phone. However, the invention is not limited by a situation where the control unit and the projection unit are different electronic equipment entities.

Referring to FIG. 1C, which is a schematic diagram illustrating a briefing system 10 according another embodiment of the invention, where it is intended to describe that the operation of the control unit 11 and the projection unit 12 performed together by the same electronic equipment entity also falls within the scope of the invention. A projection device 121 of the embodiment may be a commercial projector, or may be a display equipment having a display screen (e.g., a LCD display). The projection unit 12 may also be disposed together with the control unit 11 in the projection device 121 to become, for example, a projector having a computer system or a computer system having a projecting lens (e.g., the notebook computer, the personal computer, the tablet computer, the cell phone, etc.). For instance, the commercial projector may be connected to a USB drive (not illustrated) so the control unit 11 inside the projection device 121 may start the built-in briefing playing program, receive a briefing content 122B transmitted from the USB drive, detect a note content 132N (e.g., a memo note) corresponding to the briefing content, and transmit the note content 132N to the wearable device 13 via a communication protocol 150, such that the wearable device 13 may display the received note content 132N on the display screen 132; and meanwhile, the control unit 11 transmits the briefing content 122B to the projection unit 12 so that the briefing content 122B displayed by the projection unit 12 on a projection plane is corresponding to the note content 132N displayed by the wearable device 13 on the display screen 132.

Various details regarding the briefing system 100 in the embodiments of the invention are described as follows. Moderate extensions and improvements may be made by person who applying the embodiment according to the following details in the embodiments of the invention, and the invention is not limited only by the following disclosures.

Referring back to FIG. 1B, in the embodiment, the control unit 110 includes a processing module 112, a memory module 114, a protocol transmitting module 116 and a remote-control signal receiving module 118. Among them, the processing module 112 may be, for example, a central processing unit (CPU), a micro processor, a controller, a micro-controller unit, a digital signal processor (DSP), a programmable controller, an application specific integrated circuits (ASIC), a programmable logic device (PLD), a processing software or a controlling software, but the invention is not limited by aforesaid hardware or software. Further, the memory module 114 of the embodiment may be, for example, a hard disk, a random access memory, a virtual memory, and so on. The protocol transmitting module 116 may communicate with the protocol receiving module 134 of the wearable device 130 via the specific communication protocol 150. The remote-control signal receiving module 118 (e.g., an infrared receiver) receives a control signal transmitted by a remote-control device 160 (e.g., a remote controller having a mouse function and an infrared transmitter) controlled by the user 105.

Corresponding to the above, the user 105 may store the briefing content 122B prepared for briefing and the note content 132N (e.g., the memo note) corresponding to the briefing content 122B into the memory module 114. The briefing content 122B of the embodiment may be text, or display information composed of image and text or composed of multi-media image and interactive interface, but the invention is not limited thereto. In the embodiment, the briefing content 122B includes a plurality of briefing pages. In the embodiment, files with extensions “.ptt” or “.pdf” may be used as the briefing content 122B, but the invention is not limited thereto. Specifically, when the user 105 presents the briefing content 122B, the note content 132N mainly serves as text information or related multimedia information for reminding the user 105. The note content 132N may be text information mainly composed of a text note, but the invention is not limited thereto. In the embodiment, the note content 132N may only include a current note page corresponding to a current briefing page that is currently displayed. In other embodiments, the note content may also include a plurality of note pages corresponding to the briefing pages in the briefing content.

On the other hand, the memory module 144 stores corresponding coding or program codes of a note transmitting program. The processing module 122 may install and execute the note transmitting program by the coding or installation files of the note transmitting program. The note transmitting program may be linked to the briefing content 122B after being executed. Specifically, after being started, the note transmitting program connects to the briefing playing program, detects the briefing content 122B, and then obtains the note content 132N corresponding to the briefing content 122B.

The projection unit 120 receives the briefing content 122B from the control unit 110 in the wired/wireless manner, and displays the briefing content 122B on the projection plane 122.

Further, the wearable device 130 of the embodiment mainly includes a display screen 132, a protocol receiving module 134, a processing unit 136 and a memory 138. In the embodiment, the wearable device 130 is implemented as an electronic device in form of glasses, and the wearable device 130 in form of glasses may be disposed on a location near the eyes of the user 105. In some embodiments, the wearable device 130 may also be an electronic device in form of watch, or a contact lens having the display screen 132, where the display screen 132 is configured to display information for the user 105. In the embodiment, the display screen 132 may be an intraocular projection equipment mounted on the wearable device 130 in front of the eyes of the user 105 or a display screen with a feature of changing depth of field.

FIG. 2 is a schematic diagram of the wearable device 130 having the display screen 132 according to the embodiments of the invention, in which what located at the right of FIG. 2 is, for example, intended to clearly illustrate the note content 132N presented on the display screen 132. In some embodiments, it is also possible that the briefing content 122B corresponding to the note content 132N may also be displayed on a specific area 210 on the display screen 132, so that the user 105 does not need to turn around to re-confirm the briefing content 122B currently displayed by the projection unit 120.

Referring back to FIG. 1B, the protocol receiving module 134 of the wearable device 130 may communicate with the protocol transmitting module 116 of the control unit 110 via the specific communication protocol 150. In the embodiment, the communication protocol 150 may be a wireless protocol, such as a Bluetooth protocol, a WIFI protocol, ZigBee, ANT and infrared, etc.

The protocol transmitting module 116 and the protocol receiving module 134 are hardware used for corresponding to a communication technology field of the communication protocol 150, such as a Bluetooth signal transmitter and a Bluetooth signal receiver, WIFI transmitter and receiver, or infrared transmitter/receiver, etc. The processing unit 136 is coupled to the display screen 132 and the protocol receiving module 134, and is capable of installing and executing a note receiving program by the coding or installation files of the note receiving program. After being executed, the note receiving program receives the note content 132N from the control unit 110 via the communication protocol 150, and displays the note content 132N on the display screen 132. Further, in order to make the wearable device 130 easier to use or avoid operational false action, the wearable device 130 may be set with a plurality of modes, such as a note content (memo) uploading mode, a note content (memo) displaying mode and so on. In addition, the wearable device 130 may further include a button, a display panel or a user interface with functions such as touch control, voice control, and gesture control in order to switch between the modes or perform other operations.

In the embodiment, the memory 138 stores or temporarily stores the coding of the note receiving program and the note content 132N transmitted from the control unit 110, and the memory 138 may be a hard disk, a random access memory, a virtual memory, and so on. Among them, the processing unit 136 may be, for example, a central processing unit (CPU), a micro processor, a controller, a micro-controller unit, a digital signal processor (DSP), a programmable controller, an application specific integrated circuits (ASIC), a programmable logic device (PLD), a processing software or a controlling software. However, the aforesaid hardware or software is merely for example instead of limitation to the invention.

In the embodiment, the briefing system 100 further includes the remote-control device 160. The remote-control device 160 (e.g., the remote controller having the infrared transmitter and the mouse function) transmits the control signal to the remote-control signal receiving module 118 (e.g., the infrared receiver) in the control unit 110, so that the user 105 may transmit information regarding whether the briefing requires to change pages or transmit related control information to the control unit 110 via the remote-control device 160. Specifically, the remote-control device 160 may transmit a briefing switch signal 162 for the remote-control signal receiving module 118 to receive, the control unit 110 may control the projection unit 120 by the briefing switch signal 162 to display and switch the briefing pages in the briefing content 122B, and the control unit 110 may transmit a note switch signal corresponding to the briefing switch signal 162 to the wearable device 130 via the communication protocol 150. The wearable device 130 may display and switch a page of the note content 132N according to the note switch signal.

In another embodiment, the wearable device 130 may also include aforesaid functions of the remote-control device 160. Accordingly, the user 105 is able to use the wearable device 130 to transmit the briefing switch signal to the control unit 110 without using the remote-control device 160, so as to switch the pages of the briefing content 122B and the note content 132N corresponding to the briefing content 122B. However, in other embodiments, besides that the briefing switch signal may be transmitted by the remote-control device 160 or the wearable device 130, the user 105 or a facilitator may also directly operate the control unit 110 so that the control unit 110 may transmit the briefing switch signal. For example, an input device of the control unit 110 may be used to transmit the briefing switch signal. Specifically, the user 105 or the facilitator may use a touch panel, a keyboard or a mouse on the notebook computer (the control unit 110) to transmit the briefing switch signal to the control unit 110, so that the control unit 110 may use the projection unit 120 to switch the briefing content 122B and the control unit 110 may also use the wearable device 130 to switch the note content (memo) 132N displayed on the display screen 132.

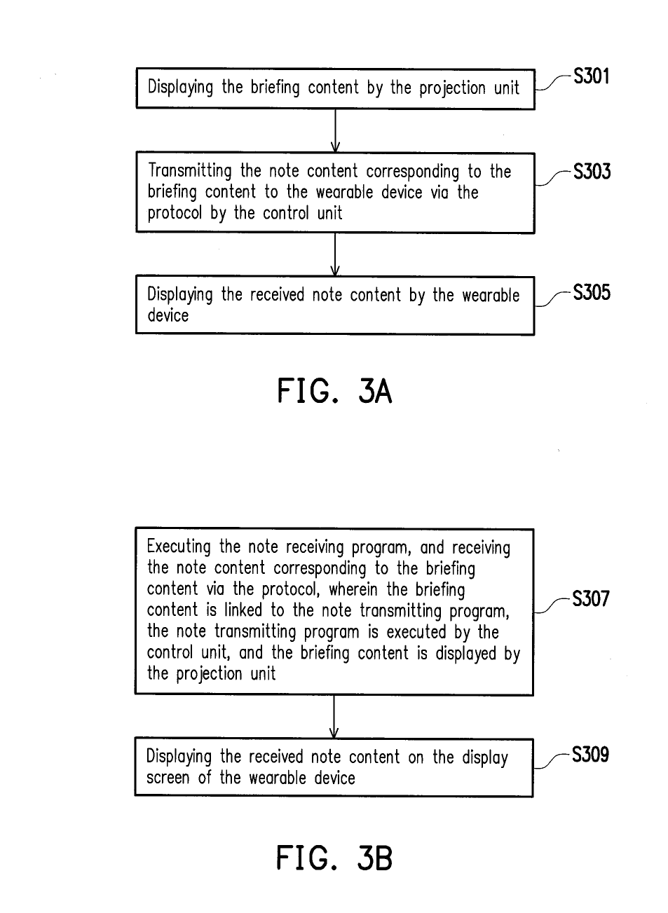

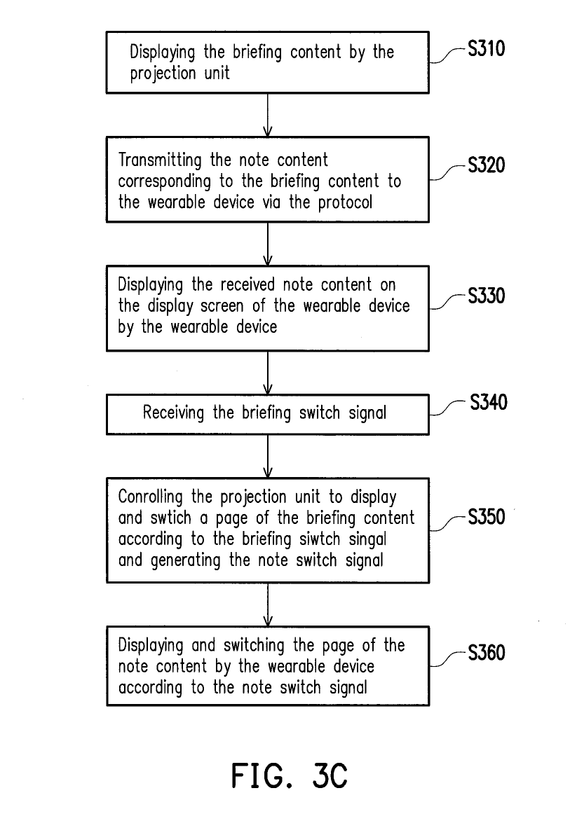

FIG. 3A, is a schematic diagram illustrating a note presentation method for briefing according to an embodiment of the invention. Referring to FIG. 1A and FIG. 3A together, based on the actions of the control unit 11, the projection unit 12 and the wearable device 13 in aforesaid briefing system 10, the note presentation method for briefing in the embodiment may be summarized into the following steps: first of all, in step S301, the briefing content 122B is displayed by the projection unit 12; subsequently, in step S303, the note content 132N corresponding to the briefing content 122B are transmitted to the wearable device 13 via the communication protocol 150 by the control unit 11; and then, in step S305, the received note content 132N is displayed by the wearable device 13. The actions for each element in the briefing system 10 have been substantially described in the foregoing embodiment, and thus related descriptions thereof are not repeated hereinafter.

FIG. 3B is a schematic diagram illustrating another note presentation method for briefing according to an embodiment of the invention. Referring to FIG. 1A and FIG. 3B together, based on the wearable device 13, the note presentation method for briefing in the embodiment may be summarized into the following steps: first of all, in step S307, the note receiving program is executed, and the note content 132N corresponding to the briefing content 122B is received via the communication protocol 150, wherein the briefing content 122B is linked to the note transmitting program, the note transmitting program is executed by the control unit 11, and the briefing content 122B is displayed by the projection unit 12; and thereafter, in step S309, the received note content 132N is displayed on the display screen 132 of the wearable device 13. The presentation of the note content 132N performed by using the wearable device 13 has been substantially described in the foregoing embodiment, and thus related descriptions thereof are not repeated hereinafter.

FIG. 3C is a schematic diagram illustrating another note presentation method for briefing according to an embodiment of the invention. In order to clearly describe details in the embodiment, the schematic diagram of FIG. 1B and the flowchart of FIG. 3C are used together to describe the briefing system and the note presentation method for briefing according to the embodiment of the invention. Referring to FIG. 1B and FIG. 3C, in the embodiment, before step S310, the note transmitting program is already installed and executed by the control unit 110, and the note receiving program is already installed and executed by the wearable device 130. Accordingly, the note transmitting program may be linked to the briefing content 122B, or the briefing content 122B may be loaded into the note receiving program of the wearable device 130. In step S310, the note transmitting program in the control unit 110 displays the briefing content 122B on the projection plane 122 by the projection unit 120, so that the audience may view the briefing content 122B. Meanwhile, in step S320, the note transmitting program of the control unit 110 transmits and stores the note content 132N corresponding to the briefing content 122B via the communication protocol 150 to the memory 138 of the wearable device 130 via the note receiving program of the wearable device 130. In step S330, the note receiving program in the wearable device 130 displays the received note content 132N on the display screen 132 of the wearable device 130 as a briefing reference for the user 105.

Corresponding to the above, in step S340, the control unit 110 receives the briefing switch signal, wherein the briefing switch signal of the embodiment may be transmitted by the user interface connected to the control unit 110, the remote-control device 160 or the wearable device 130. After the briefing switch signal is received by control unit 110, step S350 is performed, in which the control unit 110 controls the projection unit 120 to display and switch the page of the briefing content 122B according to the briefing switch signal, and generates the note switch signal corresponding to the briefing switch signal according to the briefing switch signal. Meanwhile, the control unit 110 transmits the note switch signal to the wearable device 130 via the communication protocol 150. In step S360, after receiving the note switch signal, the wearable device 130 displays and switches the page of the note content 132N according to the note switch signal.

It should be noted that, aforementioned steps S340 to S350 may include various implementations. One of the implementations is that, the note content received by the wearable device 130 only includes the current note page corresponding to the current briefing page but without the other pages. Under such circumstance, after receiving the briefing switch signal, the note transmitting program of the control unit 110 makes the note switch signal to contain a next page among the note pages corresponding to a next page among the briefing pages to be displayed by the projection unit 120, and transmits the note switch signal having the next page among the note pages to the wearable device 130 via the communication protocol 150. Accordingly, the wearable device 130 may then display the next page among the note pages on the display screen 132 by the note switch signal (which includes the next page among the note pages). Accordingly, because the note switch signal includes the next page among the note pages, the wearable device 130 may conduct a synchronous display each time after the note switch signal including the next page is received, such that the next page of the note content may be corresponding to the next page of the briefing content, and a space of the memory 138 being used may also be reduced to avoid the occurrence of insufficient memory space.

Corresponding to the above, another one of the implementations is that, the note content received by the wearable device 130 already includes all the note pages corresponding to each page of the briefing pages. Under such circumstance, after receiving the briefing switch signal, the note transmitting program of the control unit 110 makes the note switch signal to contain only a specific page signal representing the next page among the briefing pages in the briefing content (in order words, a page number or a page serial number corresponding to the briefing page to be displayed next), and transmits the note switch signal to the wearable device 130 via the communication protocol 150. Because the wearable device 130 already includes all the note pages, the wearable device 130 may simply display the note page corresponding to the specific page signal (the page serial number/page number) in the note switch signal so that the current briefing page displayed by the projection unit 120 matches the note page displayed in the wearable device 130 (that is, the current page of the note content is corresponding to the current briefing page). Accordingly, the note transmitting program of the control unit 110 may be changed together with changes in the page number of the briefing page in order to notify the display screen 132 of the wearable device 130 to change displaying of the corresponding note content by the note switch signal having the specific page signal via the communication protocol 150, such that the current note page displayed by the wearable device 130 is corresponding to the current briefing page.

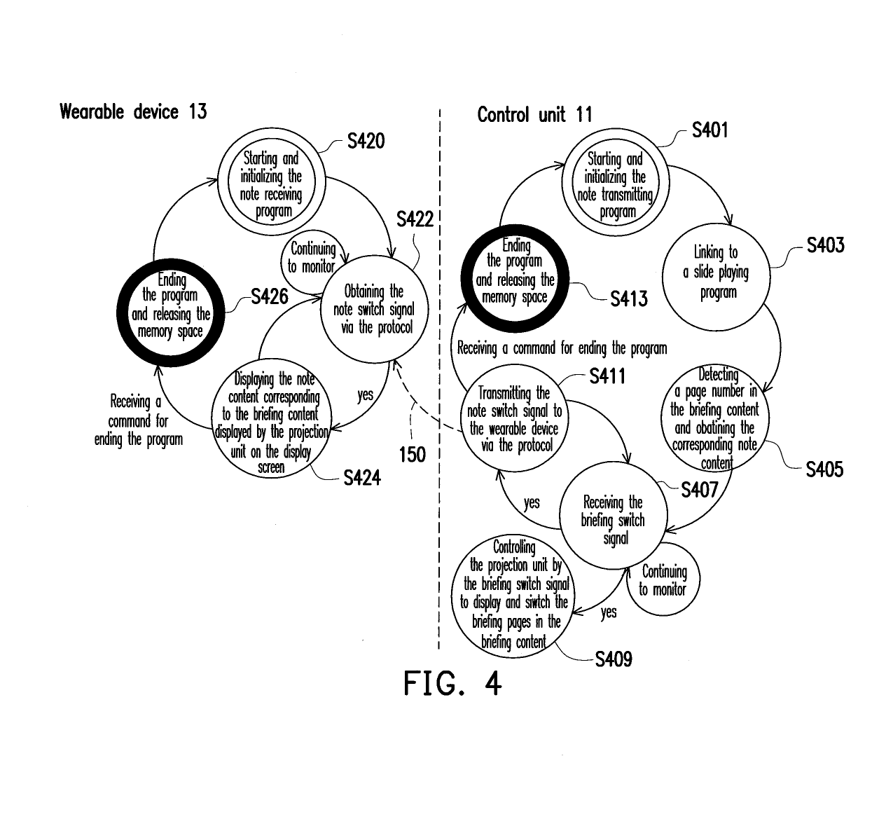

FIG. 4 is a flowchart illustrating the note presentation method for briefing performed by using the control unit 11 and the wearable device 13 in FIG. 1 according to an embodiment of the invention. The right part of FIG. 4 shows a flowchart of the method performed by the control unit 11, and the left part of FIG. 4 shows a flowchart of the method performed by the wearable device 13. Referring to FIG. 1 and the right part of FIG. 4 together, in step S401, the control unit 11 starts and initializes the note transmitting program. Thereafter, in step S403, the note transmitting program is linked to a slide playing program, so that the note transmitting program connects to the briefing content 122B. In step S405, the note transmitting program detects a page number of the briefing pages (e.g., slides) in the briefing content 122B and obtains the corresponding note content (the memo note) 132N. Then, in step S407, the note transmitting program receives the briefing switch signal transmitted from the remote-control device, the wearable device or the input device connected to the control unit. If the briefing switch signal is not received by the note transmitting program, each of signal sources (e.g., the remote-control signal receiving module, the communication protocol 150 and the input device of the control unit 11 in FIG. 2) continues to monitor whether the briefing switch signal is received in step S407.

Corresponding to the above, after the briefing switch signal is received by the note transmitting program in step S407, step S409 and S411 may be performed simultaneously. In step S409, the note transmitting program transmits the briefing switch signal to the projection unit 12, so that the projection unit 12 displays and switches the briefing pages in the briefing content. In step S411, the note transmitting program transmits the note switch signal to the wearable device 13 via the communication protocol 150. The note switch signal may contain the briefing content currently displayed and the corresponding note content, and may also contain a plurality of note pages in the note content, where the note pages are corresponding to a plurality of briefing pages respectively. After step S409 and step S411 are completed, the note transmitting program returns to step S407 to continue monitoring whether the briefing switch signal is received. Further, after a command for ending the note transmitting program is received, step S413 is performed, in which the control unit 11 ends the note transmitting program. In addition, a memory block originally occupied by the note transmitting program may be released.

Referring to FIG. 1A and the left part of FIG. 4 together, in step S420, the wearable device 13 starts and initializes the note receiving program. In step S422, the note receiving program receives the note switch signal transmitted by the control unit 11 via the communication protocol 150. If note switch signal is not received, in step S422, the note receiving program continues to monitor whether the note switch signal is received via the communication protocol 150.

Corresponding to the above, after the note switch signal is received in step S422, step S424 is performed, in which the note receiving program displays the note content 132N corresponding to the briefing content 122B displayed by the projection unit 12 on the display screen 132 of the wearable device 13. Further, after a command for ending the note receiving program is received, step S413 is performed, in which the wearable device 13 ends the note receiving program. In addition, a memory block originally occupied by the note receiving program may be released. Details regarding each steps in the flowcharts of FIG. 4 have been described in the foregoing embodiment, and thus related descriptions are not repeated hereinafter.

In summary, in the briefing system according to the embodiments of the invention, the projection unit connects to the control unit and displays the briefing content, and the wearable device communicates with the control unit via the protocol so as to display the note content corresponding to the briefing content on the wearable device. In the embodiments of the invention, the briefing system may transmit the note content (e.g., memo note) corresponding to the briefing content to the wearable device by using the note transmitting program in the control unit (e.g., the notebook computer, the smart phone, the tablet computer) and the note receiving program in the wearable device. The briefing system may also use the briefing switch signal to make the briefing content viewed by the audience through the projection unit corresponding to the memo note viewed by the user through the wearable device. Accordingly, under the circumstance where the audience can only view the briefing content, the user may view the memo note at any time through the wearable device, such that the briefing may be performed successfully, and smoothness and performance of the briefing may also be improved.

The embodiments described are chosen and described in order to best explain the principles of the invention and its best mode practical application. It is not intended to be exhaustive to limit the invention to the precise form or to the exemplary embodiments disclosed. Namely, persons skilled in the art are enabled to understand the invention through various embodiments with various modifications as are suited to the particular use or implementation contemplated. It is intended that the scope of the invention be defined by the claims appended hereto and their equivalents in which all terms are meant in their broadest reasonable sense unless otherwise indicated. Any of the embodiments or any of the claims of the invention does not need to achieve all of the advantages or features disclosed by the invention. Moreover, the abstract and the headings are merely used to aid in searches of patent files and are not intended to limit the scope of the claims of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, “first”, “second”, etc. mentioned in the specification and the claims are merely used to name the elements and should not be regarded as limiting the upper or lower bound of the number of the components/devices.

What is claimed is:

1. A briefing system, comprising:
a control unit; and
a projection unit, adapted to connect to the control unit in a wired/wireless manner and display a briefing content;
a wearable device, adapted to communicate with the control unit via a protocol, and the wearable device having a display screen, wherein the control unit transmits a note content corresponding to the briefing content to the wearable device via the protocol, and the wearable device displays the received note content on the display screen.

2. The briefing system according to claim 1, wherein the control unit controls the projection unit to display and switch a page of the briefing content according to a briefing switch signal, and the wearable device displays and switches a page of the note content on the display screen according to a note switch signal.

3. The briefing system according to claim 2, wherein the note switch signal comprises a current page of the note content for the wearable device to display after receiving the current page of the note content, wherein the current page of the note content is corresponding to a current page of the briefing content.

4. The briefing system according to claim 2, wherein the note content comprises a plurality of note pages, the note switch signal comprises a specific page signal corresponding to the briefing content, and the specific page signal is corresponding to one of the note pages, so that the wearable device is capable of displaying the note page corresponding to the current page of the briefing content after receiving the specific page signal.

5. The briefing system according to claim 1, further comprising:
a remote-control device, electrically connected to the control unit, and configured to transmit a briefing switch signal to the control unit.

6. A wearable device, comprising:
a display screen;
a protocol receiving module, adapted to communicate with a control unit via a protocol, wherein the control unit is adapted to connect to the projection unit in a wired/wireless manner to display a briefing content; and
a processing unit, coupled to the display screen and the protocol receiving module, and configured to obtain a note content corresponding to the briefing content from the control unit via the protocol and display the note content on the display screen.

7. The wearable device according to claim 6, wherein the processing unit receives a note switch signal from the control unit via the protocol, and when the processing unit receives the note switch signal, the wearable device switches a page of the note content according to the note switch signal.

8. The wearable device according to claim 7, wherein the note switch signal comprises a current page of the note content, and the wearable device displays according to the current page of the note content, wherein the current page of the note content is corresponding to a current page of the briefing content.

9. The wearable device according to claim 7, wherein the note content comprises a plurality of note pages, the note switch signal comprises a specific page signal corresponding to the briefing content, and the specific page signal is corresponding to one of the note pages, so that the wearable device is capable of displaying the note page corresponding to the current page of the briefing content according to the specific page signal.

10. A note presentation method for briefing, comprising:
displaying a briefing content by a projection unit;
transmitting a note content corresponding to the briefing content to a wearable device via a protocol by a control unit; and
displaying the received note content by the wearable device.

11. The note presentation method according to claim 10, wherein the step of transmitting the note content to the wearable device via the protocol comprises:
executing a note transmitting program by the control unit, wherein the note transmitting program is linked to the briefing content;
executing a note receiving program by the wearable device; and
transmitting the note content via the protocol by the note transmitting program to the wearable device via the note receiving program.

12. The note presentation method according to claim 10, further comprising:
receiving a briefing switch signal by the control unit;
displaying and switching a page of the briefing content by the projection unit according to the briefing switch signal;
generating a note switch signal by the control unit; and
displaying and switching a page of the note content by the wearable device according to the note switch signal.

13. The note presentation method according to claim 12, wherein the note switch signal comprises a current page of the note content, and the step of displaying and switching the page of the note content by the wearable device according to the note switch signal comprises:
after receiving the current page of the note content by the wearable device, displaying the current page by the wearable device, wherein the current page of the note content is corresponding to a current page of the briefing content.

14. The note presentation method according to claim 12, wherein the note content comprises a plurality of note pages, the note switch signal comprises a specific page signal corresponding to the briefing content, the specific page signal is corresponding to one of the note pages, and the step of displaying and switching the page of the note content by the wearable device according to the note switch signal comprises:
after receiving the specific page signal by the wearable device, displaying the note page corresponding to the current page of the briefing content by the wearable device.

15. A note presentation method for briefing, adapted to a wearable device, and the note presentation method comprising:
executing a note receiving program, and receiving a note content corresponding to a briefing content via a protocol, wherein the briefing content is linked to a note transmitting program, the note transmitting program is executed by a control unit, and the briefing content is displayed by a projection unit; and
displaying the received note content on a display screen of the wearable device.

16. The note presentation method according to claim 15, further comprising:
receiving a note switch signal; and
switching a page of the note content according to the note switch signal.

17. The note presentation method according to claim 16, wherein the note switch signal comprises a current page of the note content, and the step of switching the page of the note content according to the note switch signal comprises:
after receiving the current page of the note content, displaying the current page by the wearable device, wherein the current page of the note content is corresponding to a current page of the briefing content.

18. The note presentation method according to claim 17, wherein the note content comprises a plurality of note pages, the note switch signal comprises a specific page signal corresponding to the current briefing content, the specific page signal is corresponding to one of the note pages, and the step of switching the page of the note content according to the note switch signal comprises:
after receiving the specific page signal, displaying the note page corresponding to the current page of the briefing content.
